(19) United States
(12) Patent Application Publication
(10) Pub. No.: US 2011/0252709 A1
(43) Pub. Date: Oct. 20, 2011

(54) Multiple access door lock mechanism

(75) Inventor: Alan K. Uyeda, Irvine, CA (US)

(73) Assignee: Adams Rite Manufacturing Co.

(21) Appl. No.: 12/799,018

(22) Filed: Apr. 19, 2010

(51) Int. Cl. E05B 65/00; E05B 47/00; E06B 3/00

(52) U.S. Cl. 49/503

(57) ABSTRACT

In combination, a door, two latches at an edge of the door, and door latch operating components at opposite sides of the door; displaceable structure in the door having a position blocking movement of the latches, first mechanism responsive to displacement of one of the components for displacing the structure from blocking position to allow movement of the latches, for door opening; and electrically operable actuating means for effecting displacement of the structure from blocking position to allow movement of the latches, for door opening.

### BACKGROUND OF THE INVENTION

This invention relates generally to ease and reliability of highly responsive door unlocking mechanisms and more particularly to reliability of access to door unlocking, from both outside and inside locations, and with use of door handles as well as electronically responsive means.

There is continued need for the above referred to mechanisms, integrated in easily hand operated as well as electrically operated apparatus, installed in a door. There is also need for the simple, reliable, compact combination of elements, functioning as described and producing the improved results as will appear.

### SUMMARY OF THE INVENTION

It is a major object of the invention to provide, in combination:

a) a door, two latches at an edge of the door, and door latch operating components at opposite sides of the door,

b) displaceable structure in the door having a position blocking movement of the latches,

c) first means responsive to displacement of either of the components for displacing the structure from blocking position to allow movement of the latches, for door opening, and

d) electrically operable actuating means for effecting displacement of the structure from blocking position to allow movement of the latches, for door opening.

As will be seen, the structure typically includes a slider displaceable in response to operation of said first means, and also displaceable in response to operation of the actuating means.

A further object includes provision of a slider, movable in response to turning of either of said handles to displace the slider, allowing pivoting movement of the latches. In this regard, the actuating means may typically include a solenoid in the door and having a plunger movable to effect such structure displacement.

A frame that fits in the door typically carries the solenoid, actuating means, and slider all integrated in a highly compact combination and arrangement, to be responsive to manual operation of either of two components, as well as to electrical operation of the solenoid, thereby to facilitate unlocking of the door.

Another object is to provide two latches which are pivotally mounted in side-by-side relation, and which have latch pivoting actuating surfaces facing in opposite directions, to allow door opening in opposite directions. The latches are preferably pivotally mounted, and have their latch pivoting actuating surfaces facing in opposite directions.

Another object includes provision of actuating means that comprises a pull lever operatively connected to the slider and to a solenoid plunger, and having a first position in which retraction of the slider is blocked, and a second position in which the slider is unblocked and retracted, allowing movement of the latches. The operative connection to the slider may include a first part rigidly connected to the solenoid plunger and a second part slidably connected to said first part, and slidably connected to said lever, thereby accommodating to bodily movement of the latches and slider and a housing therefore. Also pivoting of the pull lever allows slider displacement in response to door handle turning, while remaining coupled to the inactive solenoid plunger.

Further, the actuating means typically may comprise a bodily movable dead latch pull and associated roller, the slide operatively connected to a handle, and characterized in that when the handle is turned, the slide is bodily moved to bodily move the dead latch pull which in turn pivotally displaces the lever to said second position, unblocking the two latches.

A further object includes provision of auxiliary latch means carried by the door, such that the pull lever projects between the said two latches and the auxiliary latch means. In this regard, the slider may have a first position in which it blocks pivoting of the latches, and a second position in which it is bodily displaced in two directions.

Yet another object includes provision of a housing for the two latches, and carried to be displaced laterally in a primary direction with the slider in unblocked condition, there being means to displace the slider endwise toward blocking position when the housing is returned laterally reversely relative to said primary direction. The means to so displace the slider advantageously includes cam surfaces that engage when the housing is returned laterally reversely. Such engagement may be effected by a spring located to continuously urge the housing in said reverse direction.

An added object is to orient the slider such that a spring is operable to transmit slider actuating force tending to elevate the slider as the solenoid operates to transmit force acting in opposition to said spring transmitted slider elevating force.

A yet further object is to provide for efficient operation of a door latch blocking and unblocking slider by either manually operated mechanical elements, such as a handle or handles, or a key, or alternatively by an electrically operated mechanism, in such manner that jamming of the slider unblocking movement and of the mechanical and electrical elements and their movements, is avoided. This is accomplished by highly integrated coupling and decoupling structures, operating as at opposite ends of that slider and in an installable frame, carried by a door.

These and other objects and advantages of the invention, as well as the details of an illustrative embodiment, will be more fully understood 4. from the following specification and drawings, in which:

### DRAWING DESCRIPTION

FIG. 1 is an edge view of a door, incorporating the invention;

FIG. 2 is a perspective view of an assembly of elements, incorporating the invention;

FIG. 3 is an exploded view of elements employed;

FIG. 4 is a section showing elements in detail, and their inter-relation;

FIG. 4a is a perspective view of a device to stop slider rightward travel, in slider blocking position;

FIG. 5 is like FIG. 4, but shows elements in latch unblocking position;

FIG. 6 is like FIG. 5, but shows lever or key actuation of the slider;

FIG. 7 is a perspective view showing the slider and its housing;

FIG. 8 is an exploded endwise view of elements;

FIG. 9 is an exploded view of roller elements;

FIG. 10 is a perspective view of auxiliary bolt elements; and

FIG. 11 is another endwise exploded view of elements.

### DETAILED DESCRIPTION

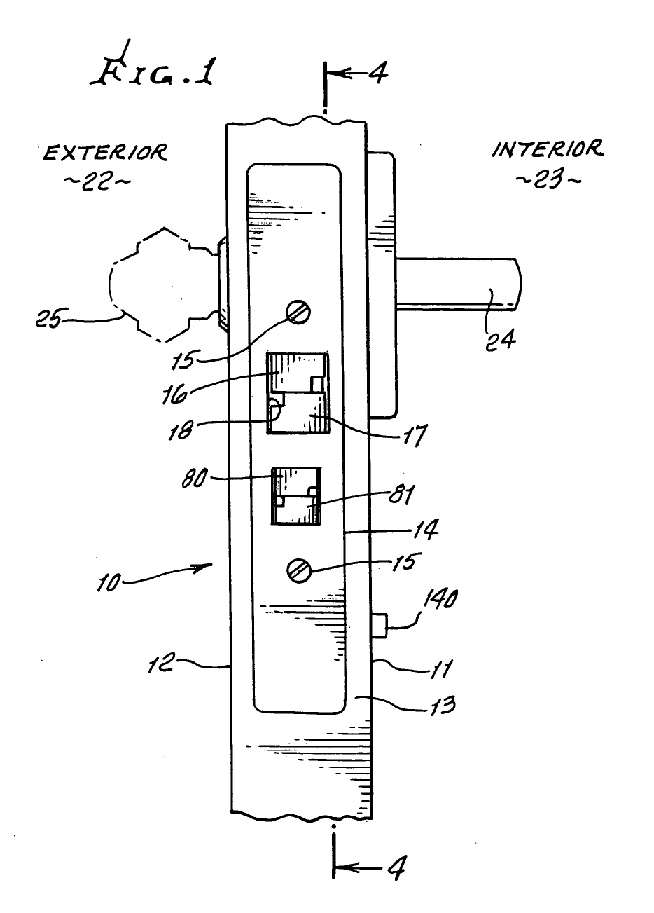

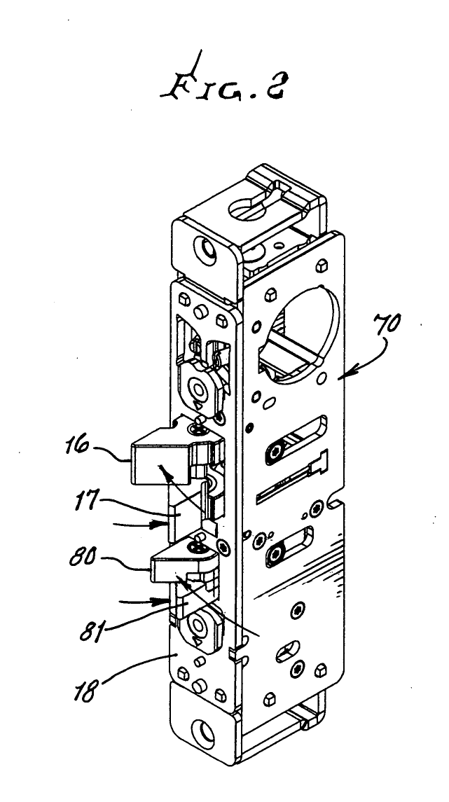

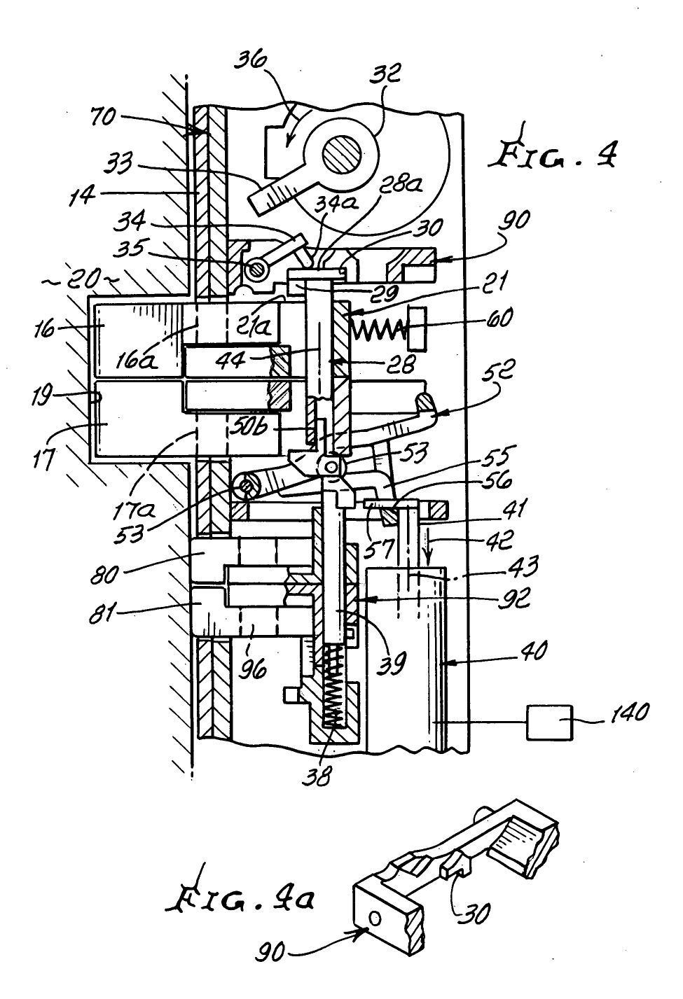

Referring first to the preferred form of the invention in FIGS. 1-5, door 10 has an interior facing side 11, an exterior facing side 12, and an upright edge 13. A trim plate 14 is attached at 15 to that edge, and two main bolts or latches 16 and 17 protrude through an opening 18 in the plate 14, for retention in an opening 19 formed by wall 20. See FIG. 4. The latches are carried by a housing 21, movable rightwardly from extended position as seen in FIG. 4 to a retracted position as seen in FIG. 5. In such FIG. 4 extended position, the latches retain the door in closed and locked position, and when the housing is in FIG. 5 retracted position, the door is unlocked, to move or swing to the exterior 22, and/or to the interior 23. Door latch operating components are indicated in FIGS. 1, at 24 and 25, at opposite sides of the door. Component 24 is shown as a rotatable handle, and component 25 is shown as a rotatable key, but may be another handle.

Displacement structure is located in the door, to have a position or positions blocking movement of the latches, as in a retracting direction, i.e. rightwardly toward FIG. 5 position. Such structure may typically include a slider 28 carried by housing 21, to have a blocking position as shown in FIG. 4, and an unblocking position as appears in FIG. 5. Slider 28 is typically carried to be movable vertically between said positions; and in the example, the slider has a head 28a projecting in a recess 29 to engage a stop shoulder 30, in its first (i.e. rightward movement blocking) position. When the slider is moved downwardly toward housing top shoulder 21a, head 28a is released from blocking position in recess 29, to be movable rightwardly with the housing as the housing and latches are displaced to the right in response to latch pivoting, as the latch or latches pivotally engage the fixed wall 20. This enables door opening. Latch pivots are indicated at 16a and 17a.

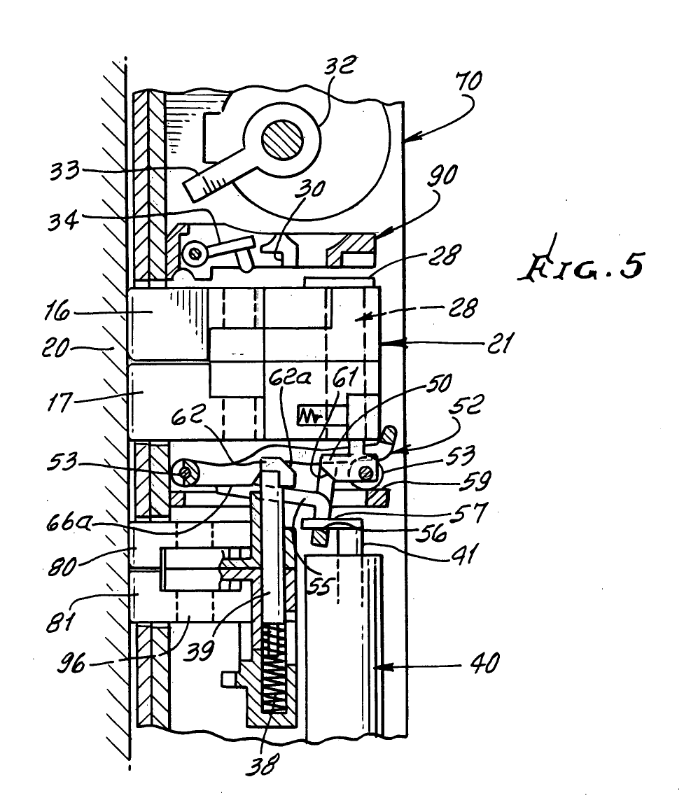

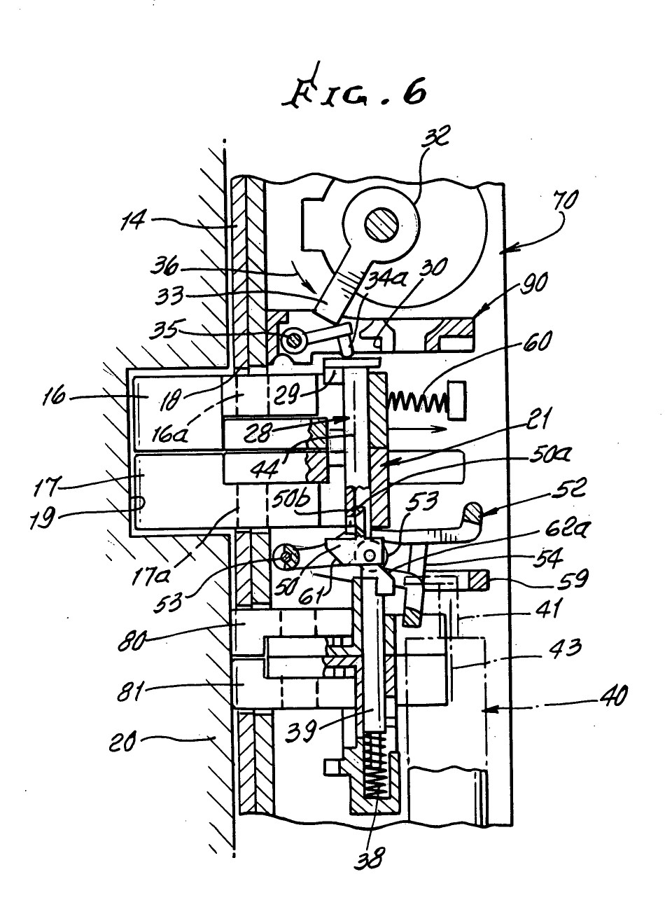

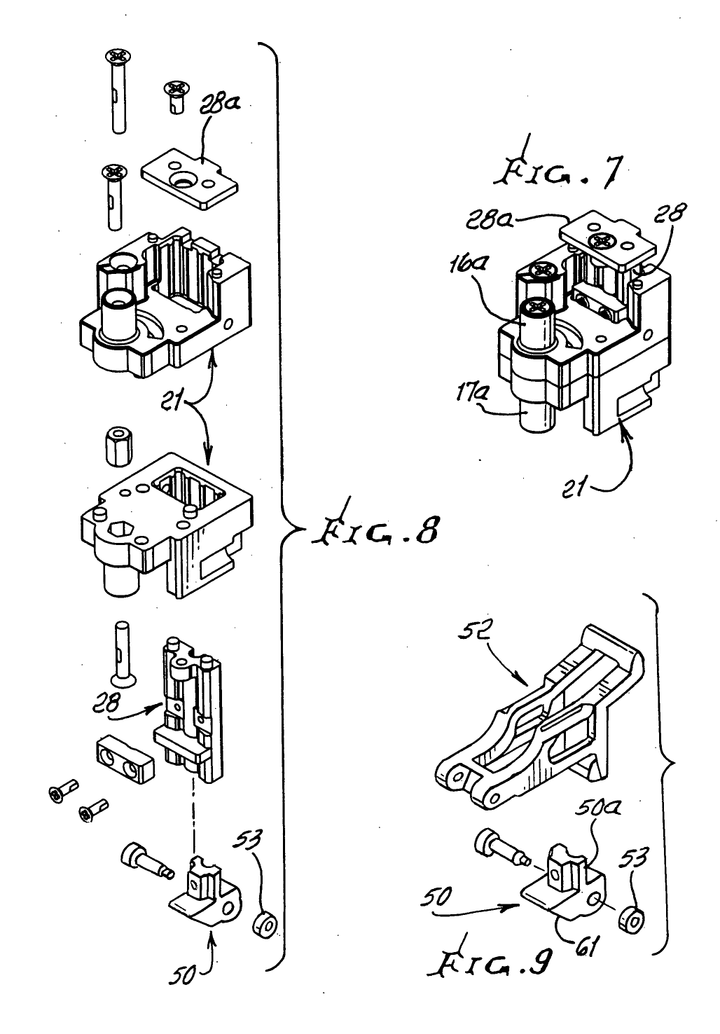

In further accordance with the invention, and operation of the preferred mechanism, first means is provided to be responsive to displacement of one of the latch operating components 24 and 25, for displacing the displaceable structure (housing 21 and/or slider 28) from blocking position, to allow pivoting movement of the latches for door opening. In unpivoted positions, the latches hold the door locked, i.e. prevented from opening. Such first means is typically mechanically actuated and may advantageously include a rotor 32 having a dog or dogging arm 33, and a release lever 34 pivoted at 35. Lever 34 has a projection 34a that presses down on slider head 28a as the rotor is turned in direction 36, thereby displacing the slider 28 downwardly to unblock bodily movement of the slider and housing 21 to the right. Such downward force is sufficient to downwardly compress a compression spring 38, and a pusher 39 acting to urge the slider upwardly in FIGS. 4 and 6.

In addition, electrically operated actuating means is provided for effecting displacement of the displaceable structures from blocking position to allow pivoting movement of the latches, for door opening. Such electrically operated actuating means may advantageously include a solenoid 40 in the door 10 and in frame 70, and actuated by push button and associated circuitry 140. The solenoid has a plunger 41 movable downwardly in response to solenoid energization, in direction 42 to effect blocking structure displacement, including downward travel of the slider 28 toward unblocking position. Note that the axis 43 of plunger travel is out of alignment with the axis 44 of slider travel, but that axes 43 and 44 are generally parallel, for compactness. In this regard, the integration of components is such that spring 38 transmits slider actuating force tending to elevate the slider toward blocking position, the energized solenoid operating to transmit force acting in opposition to such spring transmitted elevating force, and acting to lower the slider. When the solenoid is actuated, the force of spring 38 is overcome.

Coupling and decoupling mechanism shown that aids in achieving the above movements further includes a slider pull part 50 having an upward projection 50a engaging the slider at 50b; a pull lever 52 pivoted at 53 and extending generally laterally, proximate to and above a roller 53 carried by part 50; and a slide connection at 56 between an actuator 55 and a tab 57 connected to the plunger 41.

As plunger 41 is pulled down by the solenoid, the pull lever 52 is swung clockwise downwardly, to pull part 50 downwardly, pulling the slider down to unblocked position. This allows the housing 21 for the latches to be displaced to the right, as referred to above, displacing the slider and part 50 to the right, to FIG. 5 position, unlocking the door. During such displacement, roller 53 engages fixed structure horizontal surface 59, guiding rightward travel of part 50.

When the solenoid is de-energized, i.e. decoupled from the slider, leftward return travel of the housing, slider 28 and part 50 is urged by a return spring 60. An angled cam surface 61 traveling on part 50 then engages a cam surface 62a on an actuator 62 carried by pusher 39 (see FIG. 5), such engagement acting to displace the lever 52 counterclockwise, allowing the spring urged pusher 39 to displace the slider 28 back upwardly into blocking position, as seen in FIG. 4. Thus, when the solenoid is decoupled, the slider locks up, in FIG. 4 position. These movements also act to elevate the solenoid plunger, the L-shaped guide element 55 projecting under the lever 52 at 66a after assisting in this restorative functioning.

In regard to such components and movements, a frame 70 is provided to carry the components, as shown. Auxiliary bolts are pivotally carried by the frame, below pivot 53.

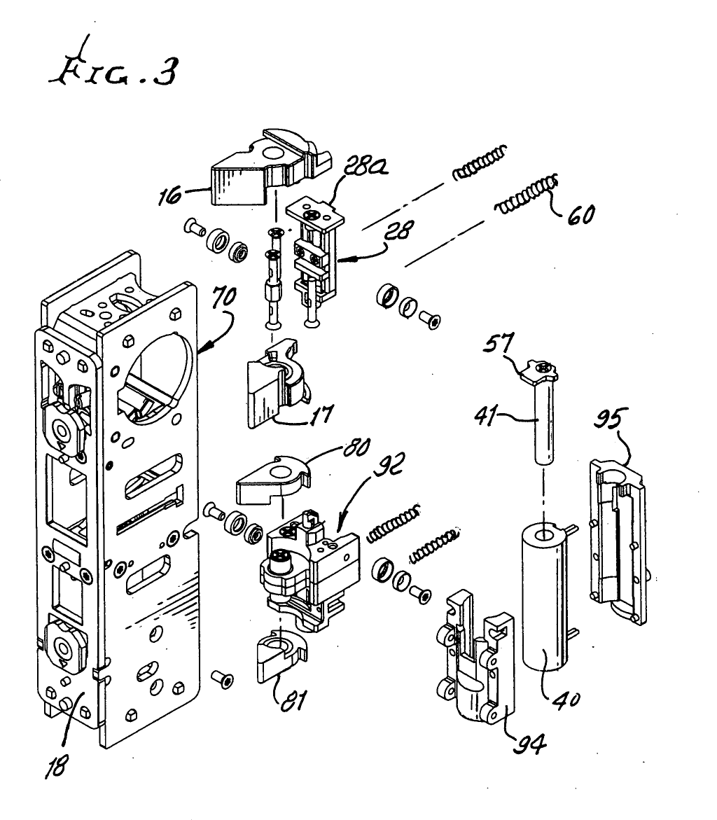

A dead latch guide 90 is shown in FIGS. 4 and 4a, to define slider head stop 30. A solenoid support cradle 94 is shown in FIG. 3, as is a solenoid cover 95.

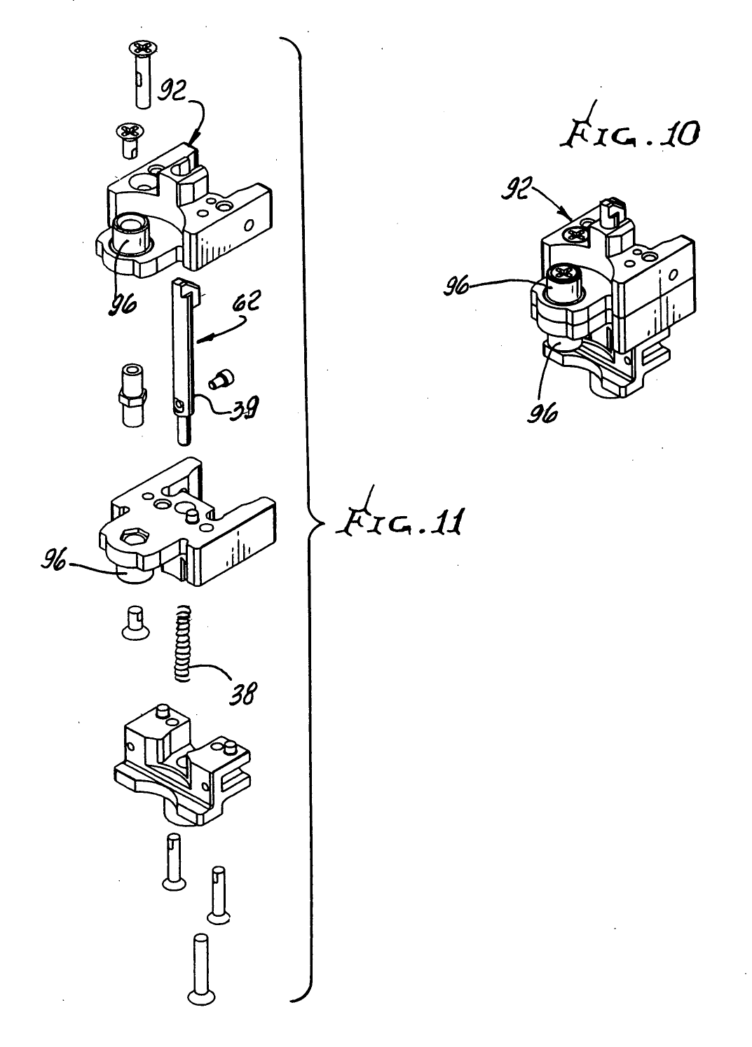

Also provided are auxiliary bolts 80 and 81 carried by the frame, via bolt body 92, below the housing 21. FIG. 10 shows mounting post 96 for the auxiliary bolt(s).

1. In combination:
a) a door, two latches at an edge of the door, and door latch operating components at opposite sides of the door,
b) displaceable structure in the door having a position blocking movement of the latches,
c) first means responsive to displacement of one of the components for displacing said structure from said blocking position to allow movement of the latches, for door opening, and
d) electrically operable actuating means for effecting displacement of said structure from said blocking position to allow movement of the latches, for door opening,
e) said structure including a slider displaceable in response to operation of said first means, and also displaceable in response to operation of said electrically operable actuating means,
f) said electrically operable actuating means being operatively decoupled from the slider when said first means is operatively coupled to the slider, and wherein said first means is operatively decoupled from the slider when the electrically operable actuating means is operatively coupled to the slider.

2. (canceled)

3. The combination of claim 1 wherein said slider is movable in response to turning of either of said components which are handles to displace the slider, allowing pivoting of the latches.

4. The combination of claim 1 wherein said actuating means includes a solenoid in the door and having a plunger movable to effect said structure displacement.

5. The combination of claim 3 wherein said actuating means includes a solenoid in the door and having a plunger movable to effect said slider displacement.

6. The combination of claim 4 including a frame fitting in the door carrying said structure, said first means, and said actuating means.

7. The combination of claim 5 including frame carrying said structure, said first means and said actuating means.

8. The combination of claim 1 wherein said two latches are pivotally mounted, and have latch pivoting actuating surfaces facing in opposite directions.

9. The combination of claim 7 wherein said two latches are pivotally mounted, in side-by-side relation and have latch pivoting actuating surfaces facing in opposite directions.

10. In combination:
a) a door, two latches at an edge of the door, and door latch operating components at opposite sides of the door,
b) displaceable structure in the door having a position blocking movement of the latches,
c) first means responsive to displacement of one of the components for displacing said structure from said blocking position to allow movement of the latches, for door opening, and
d) electrically operable actuating means for effecting displacement of said structure from said blocking position to allow movement of the latches, for door opening, said structure including a slider displaceable in response to operation of said first means, and also displaceable in response to operation of said electrically operable actuating means and wherein said actuating means comprises a pull lever operatively connected to the slider and to a solenoid plunger, and having a first position in which retraction of the slider is blocked, and a second position in which the slider is unblocked and retracted, allowing movement of the latches.

11. The combination of claim 10 wherein the operative connection to the slider includes a first part rigidly connected to the solenoid plunger and a second part slidably connected to said first part, and slidably connected to said lever, thereby accommodating to bodily movement of the latches and slider and a housing therefore.

12. The combination of claim 11 including a spring urged pusher located to exert pushing force transmitted to the slider for displacing the pull lever toward said first position.

13. The combination of claim 10 wherein said actuating means comprises a bodily movable dead latch pull and associated roller, the slider operatively connected to a handle, and characterized in that when the handle is turned, the slider is bodily moved to bodily move the dead latch pull which in turn pivotally displaces the lever to said second position, unblocking the two latches.

14. The combination of claim 10 including auxiliary latch means carried by the door, such that the pull lever projects between the said two latches and the auxiliary latch means.

15. The combination of claim 13 wherein the slider has a first position in which it blocks pivoting of the latches, and a second position in which it is bodily displaced in two directions.

16. The combination of claim 15 including a housing for the two latches, and carried to be displaced laterally in a primary direction with the slider in unblocked condition, there being means to displace the slider endwise toward blocking position when the housing is returned laterally reversely relative to said primary direction.

17. The combination of claim 16 wherein said means to displace the slider includes cam surfaces that engage when the housing is returned laterally reversely.

18. The combination of claim 17 including a spring located to continuously urge the housing in said reverse direction.

19. The combination of claim 4 including a spring transmitting slider actuating force tending to elevate the slider as the solenoid operates to transmit force acting in opposition to said spring transmitted slider elevating force.

20. The combination of claim 1 wherein said first means includes a rotor having a dog, and a lever provided by the dog to mechanically displace the slider to unblocking position.

21. The combination of claim 10 wherein said electrically operable actuating means is operatively decoupled from the slider when said first means is operatively coupled to the slider, and wherein said first means is operatively decoupled from the slider when the electrically operable actuating means is operatively coupled to the slider.
